(19) United States
(12) Patent Application Publication
(10) Pub. No.: US 2007/0073869 A1
(43) Pub. Date: Mar. 29, 2007

(54) SYSTEM AND METHOD FOR TRANSMITTING DATA

(75) Inventors: Wei-Hua Guan, Shenzhen (CN); Sha Li, Shenzhen (CN); Gan-Quan Liu, Shenzhen (CN)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Taipei Hsien (TW)

(21) Appl. No.: 11/309,401

(22) Filed: Aug. 4, 2006

(30) Foreign Application Priority Data
Aug. 26, 2005 (CN) 200510036910.6

(51) Int. Cl. G06F 15/173

(52) U.S. Cl. 709/224

(57) ABSTRACT

A method for transmitting data includes the steps of: identifying data that is transmitted from a first server (2) to a second server (3); filtering out sensitive/confidential data from the identified data according to predefined security definitions to generate a filtered data that exclude any sensitive/confidential data; detecting whether the identified data entirely consist of sensitive data; formatting the filtered data into one or more of data packets if the identified data does not entirely consist of sensitive/confidential data; sending data receiving requests to the second server; monitoring the data receiving requests sent by the first server; receiving the one or more data packets transmitted from the first server if the data receiving requests are accepted; reassembling the one or more data packets into reassembled data; and transmitting the reassembled data to client computers (5) connected with the second server. A system for transmitting data securely is also disclosed.

### FIELD OF THE INVENTION

The present invention generally relates to systems and methods for managing data, and more particularly to a system and method for transmitting data.

### DESCRIPTION OF RELATED ART

With the continual technology advancement of computer servers and the Internet, searching and obtaining relevant information from a potential customer or a supplier via the Internet has become an important task for more and more people, usually the relevant information are exchanged by client-server architectures.

There is generally two type of information exchange relating to businesses—one is to transmit information (for example, product information, service information) from a supplier computer to a buyer/purchaser computer, another is to transmit information (for example, request information, trade information) from a buyer/purchaser computer to a supplier computer.

A general data exchange technique, such as a data backup technique is used for periodically transmitting desired data from its resource to a remote data storage medium. Unfortunately, the data, including sensitive/confidential data are exchanged between a client computer and a supplier computer is not secure.

What is needed, therefore, is a system and method for transmitting data, that can exchange data between client computers and supplier computers securely.

### SUMMARY OF INVENTION

A system for transmitting data in accordance with a preferred embodiment includes a first server and a second server both installed with a management program. The management program includes an identifying module, a detecting module, a receiving and analyzing module, a managing module, and a monitoring module. The identifying module is configured for identifying data that is transmitted between the first server and the second server, and for filtering out sensitive/confidential data from the identified data according to predefined security definitions to generate filtered data that exclude any sensitive/confidential data. The monitoring module is configured for monitoring data receiving requests sent from the first server. The detecting module is configured for detecting whether the identified data entirely consist of sensitive/confidential data, and for detecting whether the data receiving requests sent from the first server have been accepted. The receiving and analyzing module is configured for formatting the filtered data into one or more data packets if the identified data does not entirely consist of sensitive/confidential data, and for receiving the data packets transmitted by the first server. The managing module is configured for sending the data receiving requests to the second server, reassembling the one or more data packets into reassembled data, and transmitting the reassembled data to client computers connected with the second server.

A method for transmitting data in accordance with a preferred embodiment includes the steps of: identifying data that is transmitted from a first server to a second server; filtering out sensitive/confidential data from the identified data according to predefined security definitions to generate a filtered data that exclude any sensitive/confidential data; detecting whether the identified data entirely consist of sensitive data; formatting the filtered data into one or more of data packets if the identified data does not entirely consist of sensitive/confidential data; sending data receiving requests to the second server; monitoring the data receiving requests sent by the first server; receiving the one or more data packets transmitted from the first server if the data receiving requests are accepted; reassembling the one or more data packets into reassembled data; and transmitting the reassembled data to client computers connected with the second server.

Other advantages and novel features of the present invention will become more apparent from the following detailed description of preferred embodiments when taken in conjunction with the accompanying drawings.

### BRIEF DESCRIPTION OF DRAWINGS

FIG. 1 is a schematic diagram of hardware configuration of a system for transmitting data in accordance with a preferred embodiment;

FIG. 2 is a schematic diagram of various function modules of a management program; and

FIG. 3 is a flowchart of a method for transmitting data by implementing the system of FIG. 1.

### DETAILED DESCRIPTION

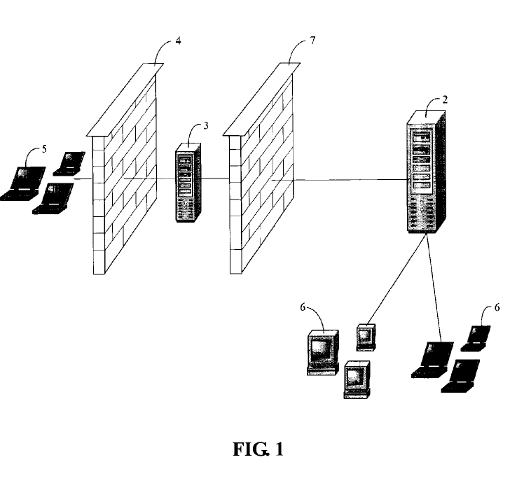

FIG. 1 is a schematic diagram of hardware configuration of a system for transmitting data (hereinafter, “the system”) in accordance with a preferred embodiment. The system includes: an application server 2 connected with a plurality of internal client computers 6, and a demilitarized zone (DMZ) server 3 connected with a plurality of external client computers 5 via an external firewall 4. The application server 2 connects with the DMZ server 3 via an internal firewall 7. Both the application server 2 and the DMZ server 3 are installed with a management program for synchronously exchanging data between the plurality external client computers 5 and the plurality internal client computers 6. Both the external firewall 4 and the internal firewall 7 are configured for preventing the application server 2 from being corrupted with computer viruses, trojan horses, worms, adwares, or any other malicious programs and/or hackers with malicious intent.

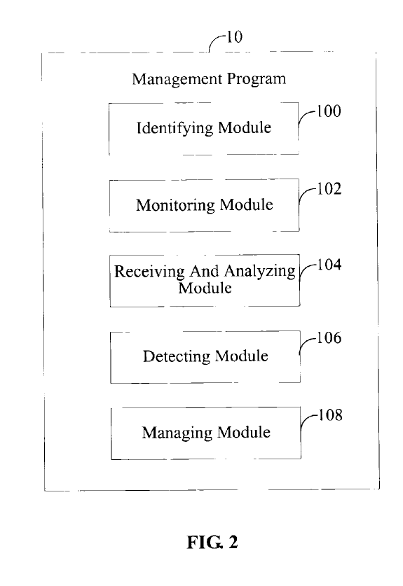

FIG. 2 is a schematic diagram of various function modules of the management program 10. The management program 10 includes an identifying module 100, a monitoring module 102, a receiving and analyzing module 104, a detecting module 106, and a managing module 108.

The identifying module 100 is configured for identifying data that is to be exchanged between the plurality of internal client computers 6 and plurality of the external client computers 5, and for filtering out sensitive/confidential data from the identified data according to security definitions predefined by an enterprise to generate a filtered data that exclude any sensitive/confidential data. The sensitive/confidential data typically include customer information, employee information, production information, and supplier information. The security definitions are used for regulating data that is allowed by the enterprise to be exchanged between the plurality of internal client computers 6 and the plurality of external client computers 5 only.

The monitoring module 102 is configured for monitoring data receiving requests sent from the application server 2 or the DMZ server 3.

The receiving and analyzing module 104 is configured for formatting the filtered data into a plurality of data packets to be transmitted via a network, and for receiving the plurality of data packets transmitted from the application server 2 or the DMZ server 3.

The detecting module 106 is configured for detecting whether the identified data entirely consist of sensitive/confidential data, and for detecting whether the data receiving requests have been accepted by the monitoring module 102.

The managing module 108 is configured for sending data receiving requests to the DMZ server 3 or the application server 2, reassembling the data packets into reassembled data, transmitting the reassembled data to the external client computers 5 or the internal client computers 6, and returning a response message to inform the application server 2 or the DMZ server 3 of the data exchanged status; i.e., if the data exchange is successful or unsuccessful.

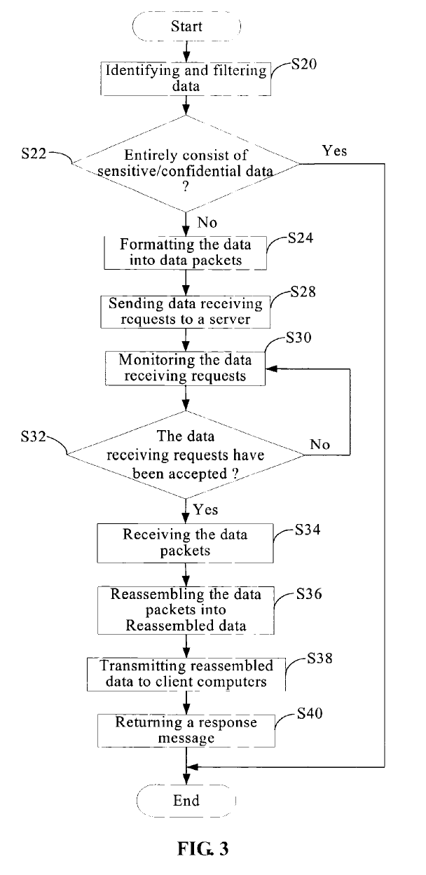

FIG. 3 is a flowchart of a method for transmitting data by implementing the system described above. In the preferred embodiment, an enterprise may use the system to transmit data from a product representative within the enterprise to an external customer.

In step S20, the identifying module 100 installed in the application server 2 identifies the data to be transmitted, and filters out sensitive/confidential data from the identified data according to security definitions predefined by the enterprise to generate a filtered data that exclude any sensitive/confidential data.

In step S22, the detecting module 106 installed in the application server 2 detects whether the identified data entirely consist of sensitive/confidential data. If the identified data does not entirely consist of sensitive/confidential data, in step S24, the receiving and analyzing module 104 installed in the application server 2 formats the filtered data into one or more data packets to be transmitted via a network. Otherwise, if the identified data entirely consist of sensitive/confidential data (meaning the entire data to be transmitted is not allowed due to security risks), the procedure ends.

In step S28, the managing module 108 installed in the application server 2 sends a data receiving request to the DMZ server 3.

In step S30, the monitoring module 102 installed in the DMZ server 3 monitors the data receiving request sent from the application server 2.

In step S32, the detecting module 106 installed in the DMZ server 3 detects whether the data receiving request has been accepted. If the data receiving request has been accepted, in step S34, the receiving and analyzing module 104 installed in the DMZ server 3 receives the data packets from the application server 2. Otherwise, if the data receiving request has not been accepted, the procedure goes directly to step S30 described above.

In step S36, the managing module 108 installed in the DMZ server 3 reassembles the one or more data packets into reassembled data. In step S38, the managing module 108 installed in the DMZ server 3 transmits the reassembled data to an external client computer 5. In step S40, the managing module 108 installed in the DMZ server 3 returns a response message to inform the application server 2 of the data exchanged status; i.e., if the data exchange is successful or unsuccessful.

An alternative embodiment of the method can be used for receiving data transmitted from the external customer to the representative of the enterprise securely. In the alternative embodiment, the data is to be transmitted from the DMZ server 3 to the application server 2. In the alternative embodiment, step S20, step S22, step S24, step S28 step S30, step S32, step S34, step S36, step S38, and step S40 are executed as described except that all instance of the application server 2 is replaced with the DMZ server 3 and vice versa.

Although the present invention has been specifically described on the basis of a preferred embodiment and a preferred method, the invention is not to be construed as being limited thereto. Various changes or modifications may be made to said embodiment and method without departing from the scope and spirit of the invention.

What is claimed is:

1. A system for transmitting data, the system comprising a first server and a second server both installed with a management program, the management program comprising:
an identifying module configured for identifying data that is transmitted between the first server and the second server, and for filtering out sensitive/confidential data from the identified data according to predefined security definitions to generate filtered data that exclude any sensitive/confidential data;
a monitoring module configured for monitoring data receiving requests sent from the first server;
a detecting module configured for detecting whether the identified data entirely consist of sensitive/confidential data, and for detecting whether the data receiving requests sent from the first server have been accepted;
a receiving and analyzing module configured for formatting the filtered data into one or more data packets if the identified data does not entirely consist of sensitive/confidential data, and for receiving the data packets transmitted by the first server; and
a managing module configured for sending the data receiving requests to the second server, reassembling the one or more data packets into reassembled data, and transmitting the reassembled data to client computers connected with the second server.

2. The system as claimed in claim 1, wherein the managing module is further configured for returning a response message to inform the first server of the data exchanged status.

3. The system as claimed in claim 1, wherein the security definitions are used for regulating data that are allowed to be transmitted between the first server and the second server.

4. The system as claimed in claim 1, wherein the data transmitted between the first server and the second server comprise customer information, employee information, production information, and supplier information.

5. A method for transmitting data, the method comprising the steps of:
identifying data that is transmitted from a first server to a second server;
filtering out sensitive/confidential data from the identified data according to predefined security definitions to generate a filtered data that exclude any sensitive/confidential data;
detecting whether the identified data entirely consist of sensitive data;
formatting the filtered data into one or more of data packets if the identified data does not entirely consist of sensitive/confidential data;
sending data receiving requests to the second server;
monitoring the data receiving requests sent by the first server;
receiving the one or more data packets transmitted from the first server if the data receiving requests are accepted;
reassembling the one or more data packets into reassembled data; and
transmitting the reassembled data to client computers connected with the second server.

6. The method as claimed in claim 5, further comprising the step of:
returning a response message to inform the first server of the data exchanged status.

7. The method as claimed in claim 5, wherein the security definitions are used for regulating data that are allowed to be exchanged between the first server and the second server.

8. The method as claimed in claim 5, wherein the data transmitted from the first server to the second server comprise customer information, employee information, production information, and supplier information.
